(19) United States
(12) Patent Application Publication
(10) Pub. No.: US 2018/0322535 A1
(43) Pub. Date: Nov. 8, 2018

(54) IMPRESSION CAPPING IN DISTRIBUTED ONLINE ADVERTISING ENVIRONMENT

(71) Applicant: Pubmatic, Inc., Redwood City, CA (US)

(72) Inventors: Rohan BANKAR, Pune (IN); Divyesh MINJROLA, Pune (IN); Ramkrishan RAVI, Munger (IN)

(21) Appl. No.: 16/039,554

(22) Filed: Jul. 19, 2018

Related U.S. Application Data
(63) Continuation of application No. 14/276,654, filed on May 13, 2014.

(51) Int. Cl. G06Q 30/02; G06F 17/30

(52) U.S. Cl. CPC G06Q 30/0272; G06Q 30/0277; G06F 17/30365

(57) ABSTRACT

Ad segments on a Web page are filled with ads that are served by a service provider operating between a user computer and publisher on one end and multiple ad serving entities on the other. The service provider implements a bidding process for the ad segment. Impression caps may be imposed over geographically separate data centers. An individual server in a data center may dynamically request information from a central store to update a local impression cap quota.

### TECHNICAL FIELD OF THE INVENTION

This application is a Continuation of U.S. application Ser. No. 14/276,654, filed on May 13, 2014, the contents of which are incorporated herein by reference in its entirety

### BACKGROUND OF THE INVENTION

The online advertising industry is growing increasingly sophisticated. As the number of display ads grows, driven mainly by more intelligent programmatic ad buying capabilities, the amount of control that publishers (entities who have an inventory of advertising space to sell) want with respect to selling this ad space inventory grew. And with it the value of the publisher's inventory rose as well. There is an increasing desire among publishers to carve out specific inventory buckets for their ad space inventory. On the advertiser side, advertisers are now increasingly particular about how much they will pay to place their ads on Web pages. Presently, prices for paying for ad space is based on fairly generic level controls, such as Web site traffic, location on Web page, visibility on page, and the like. The specific audience, that is, who would see the ad, does not play a role in determining the value of an ad space or segment.

Referring to FIG. 1, an online advertising system may include an ad server that acts as an intermediary between publishers and advertisers. This may include providing real time bidding for ad segments served to individual users viewing web pages of publishers.

One aspect of the online advertising industry is that ads may be served to users across large geographic areas. For example, an individual publisher may have a website that is viewed by people within large geographic areas, including different countries around the world. As a result, the online ads will typically be served from geographically distributed servers. Thus, in the example of FIG. 1, local servers (not shown) would be provided in individual geographic regions to provide acceptable response times to consumers.

Providing a geographically distributed online advertising service generates a problem in controlling the number of impressions served. In many applications it is desirable to have a cap on the number of impressions for a particular campaign, creative, real time bidding, or ad network. This is also known as an impression cap. However, coordinating impression caps in a distributed online advertising environment is difficult.

Therefore, it would be desirable to provide tools for improved control of serving impressions in an online advertising campaign.

### SUMMARY OF THE INVENTION

In one aspect of the preset invention, a method of serving ads to ad segments on Web pages is described. Impression caps may be imposed on geographically distributed data centers. In an individual data center a server may dynamically request information to update a local impression cap at the server. The rules for determining an impression cap for a server may include selecting the impression cap to be a small fraction of a total impression cap for a data center to minimize under/over serving. Additionally, the impression cap may be selected to be sufficiently large to keep latency within acceptable limits. Additionally, other rules may be imposed on the impression cap at the local server. After a server exhausts an impression cap quota it dynamically requests information from a central store to update its impression cap quota. Additional monitoring of actual impressions served may be used to aid in determining the number of remaining impressions to be served by the servers of a data center.

### BRIEF DESCRIPTION OF THE DRAWINGS

The invention and the advantages thereof may best be understood by reference to the following description taken in conjunction with the accompanying drawings in which:

FIG. 1 is a block diagram showing the entities and relationships for controlling advertising in accordance with the prior art;

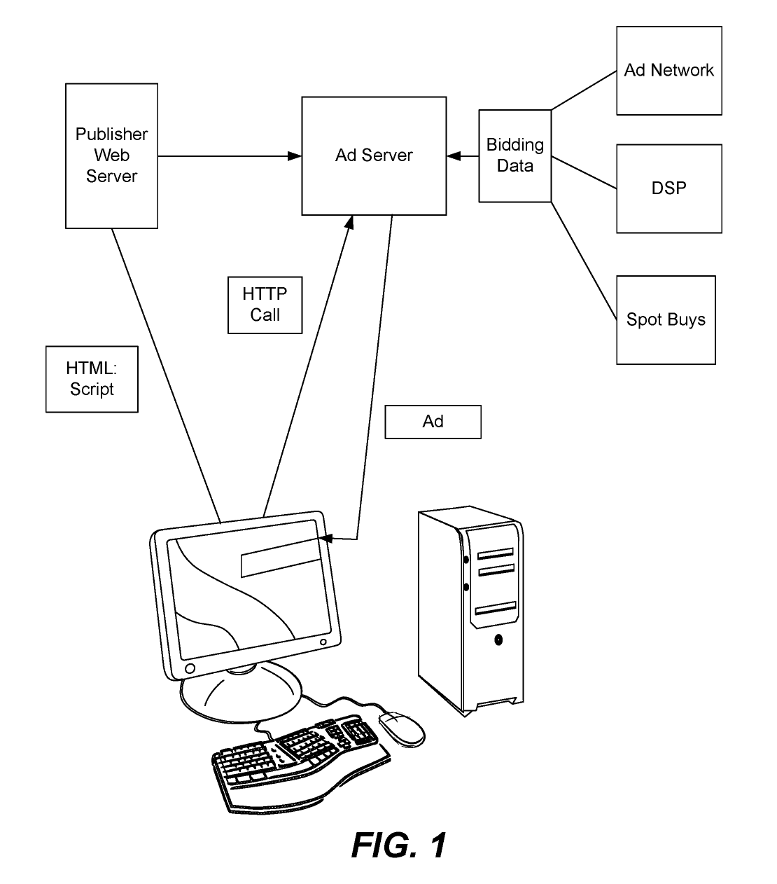

FIG. 2 is a block diagram illustrating geographically distributed impression capping in accordance with an embodiment of the present invention;

FIG. 3 illustrates impression capping at a data center in accordance with an embodiment of the present invention; and

FIGS. 4A and 4B are flow charts illustrating embodiments of methods of the present invention.

In the drawings, like reference numerals are sometimes used to designate like structural elements. It should also be appreciated that the depictions in the figures are diagrammatic and not to scale.

### DETAILED DESCRIPTION OF THE INVENTION

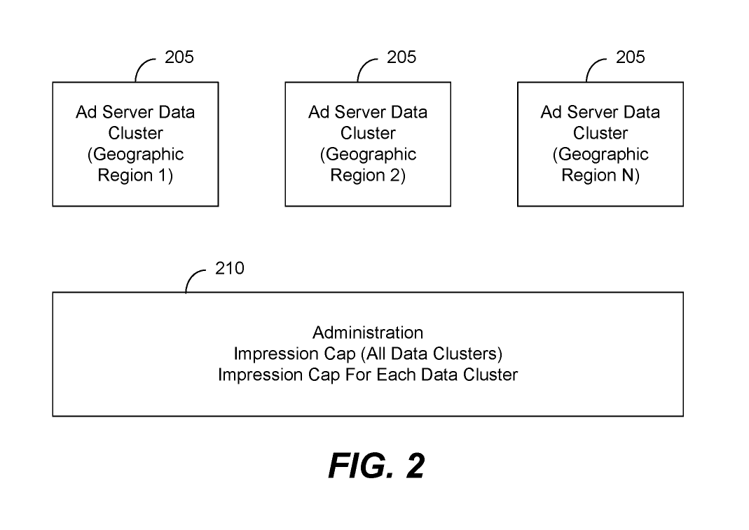

Methods, systems, and computer readable media for impression capping in an online advertising distributed environment are described. FIG. 2 is a high level block diagram of an embodiment of the present invention. In one embodiment impression caps are distributed at the data center level. The distributed system has multiple data centers 205 in different geographic areas (e.g., different time zones as one example). Each data center 205 has one or more data clusters where an individual cluster includes a group of servers. An individual cluster may serve a single type of inventory or multiple types of inventory. Examples of inventory include ad segments for mobile devices, web, video, or combinations. An impression cap may have daily, hour, lifetime, and geographic level limits. The effective Cost Per Mil (e-CPM) may also vary. As an illustrative example, assume two inventories, inventory ‘a’ and inventory ‘b’. Inventory ‘a’ has an e-CPM of $2 and inventory ‘b’ has an e-CPM of $1. A total targeted impressions may be 150,000 with 100,000 impressions from inventory a and 50,000 impressions from inventory ‘b’. Additional administration 210 may be provided to provide an impression cap for all of the data centers.

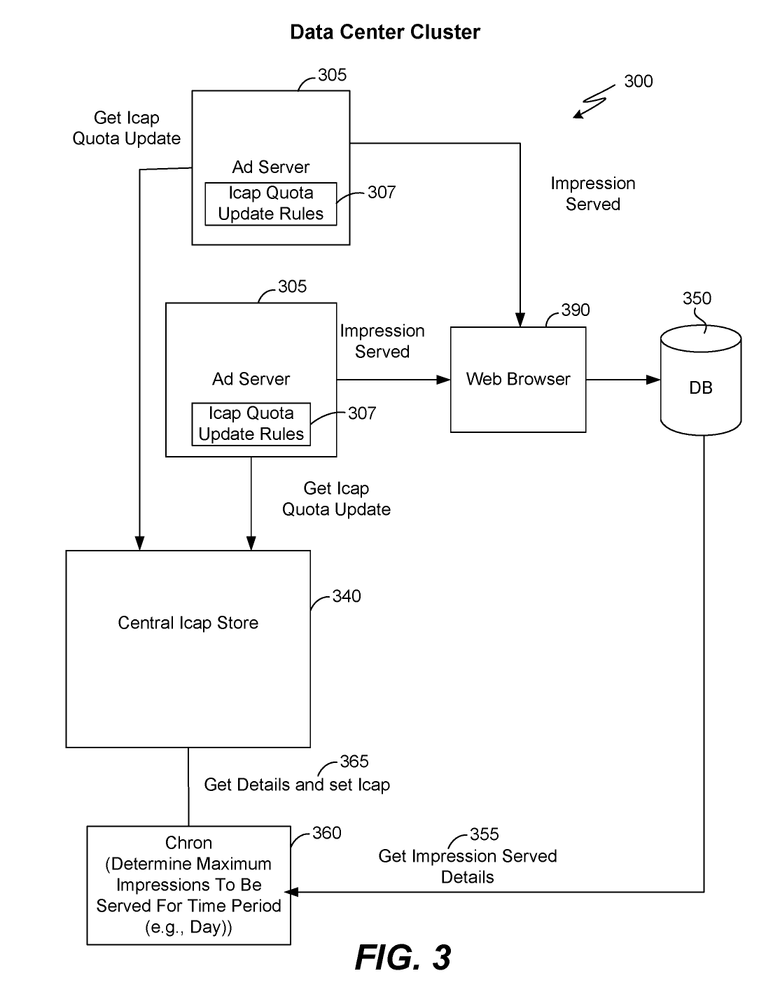

FIG. 3 illustrates in more detail an individual data center 300 with two or more ad servers 305 to serve impressions to the browser 390 of client computers within a geographical region. Each individual server 305 fetches an impression cap (icap) quota from a central icap store 340. Each server 305 serves impressions to web browsers and this information on served impression is recorded in a database 350. A chronological (cron) analysis module 360 is a unit that analyzes the served impression details. This chronological information is used to determine what the remaining portion of the icap at the central icap store 340 is and this information may be used to refine impression cap updates given to individual servers 305. An individual server 305 may include a rules module 307 to define the rules for the icap quota updates. In one embodiment the cron analysis module 360 gets the impression served details and determines the impressions to be served and set in the central icap store 340. When an ad-server 307 gets an icap quota from the central icap store 340, the icap quota is deducted from the central icap count.

In one embodiment a get impression served details 355 command is used for the cron analysis modules 360 to fetch information on impressions served. The central icap store 340 may use a get details and set icap command 365 to get the chronological information, which may include information on the number of impressions to be served and the impressions actually served.

Each individual server 305 of the data center 300 fetches an icap quota from the central icap store 340 keeps the fetched quota locally at the server. Once that icap quota has been exhausted at the individual server, the server will then fetch an updated icap quota from the central icap store and continue to serve impressions. The process of each server fetching an updated icap quota each time a previous icap quota is exhausted continues until the remaining icap quota in the central icap store 340 is exhausted.

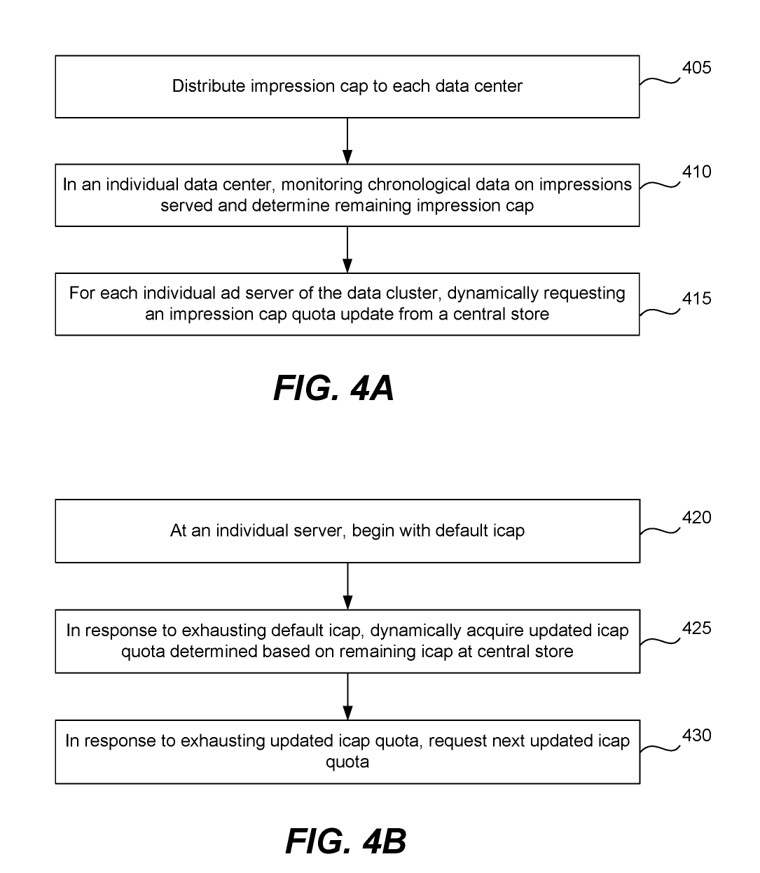

FIG. 4A illustrates an exemplary method in accordance with an embodiment of the present invention. An impression cap is distributed to each data center in block 405. In an individual data center, there is monitoring of chronological data on impressions served and determining of remaining impression cap for a central store in block 410. Each individual server of the data center dynamically requests in block 415 an impression cap quota update from the central store after it has exhausted its previous impression cap.

FIG. 4B illustrates an exemplary method for a server to dynamically request updates. An individual server begins with a default icap quota in block 420. This default could, for example, be a small starting quota, such as 1 impression. This initial default icap quota is exhausted after the corresponding number of impressions is served. The server then dynamically acquires and updates the icap quota from the central store in block 425. This updated icap quota may be a fixed number. However, more generally it may be adjusted based on the remaining icap at the central store. For example, one or more rules may be applied as the remaining icap decreases to reduce the icap quota. The individual server may then exhaust the updated icap quota and request a new (next) icap quota from the central store in block 430.

As an illustrative example, assume that there is an impression cap (icap) of 100,000 for a given data center. Suppose there are servers A, B, and C of different clusters. Suppose server A fetches an icap quota of 100 and keeps it at the server locally. Once the 100 impressions are served by that server, it will again fetch an updated quota (e.g., 100) from the central store. Several different aspects are illustrated by this example. In this example the impression cap quota is small compared with the total icap for the data center. Thus, there is a low chance of over-serving or under-serving. However, the icap quota is also large enough so that the icap quota is not always updated from the central store. That is, the icap quota is selected to be large enough to keep latency within acceptable limits. Additionally, the use of the central store eliminates the need to maintain cluster information to control the impression cap. Moreover, because the data center is monitoring the actual impressions served, the remaining inventory can be determined and used to refine the icap quota updates based on the remaining inventory.

### Exemplary Server Algorithm

As previously discussed an individual server 305 may include a rules module 307 to update the icap quota. An exemplary server algorithm to update the icap quota will now be described in accordance with an embodiment of the present invention. In one embodiment, on each server call request, the following steps are implemented by the server:

1. Get related winnable inventory having impression cap enabled.

2. If icap data is not available locally for an inventory take a default icap, where an exemplary default icap may be set to be a small number such as 1. Setting the default icap to be a small value avoids a first time huge update request to the central data store. Moreover, setting the default icap to be a small number, such as 1, can be accommodated while an estimation is performed at the centralized data store of the remaining icap for the data center.

3. Determine if the icap data is available locally but <=0, and if the icap is available at the central store. For this case, fetch icap quota as per icap available at central store, decrement same at central store and store it locally for further use.

4. If the inventory having icap wins, then decrement the icap count for the same inventory by 1 locally, then again go through step 3 to update icap if required.

In one embodiment a rule is provided for the local Icap data to expire based on a condition, such after a pre-selected time or other condition.

As an illustrative example suppose for an ad request that c1, c2, c3, c4 are different types of active inventory each having icap enabled. Then in one embodiment the following steps will be followed by the server:

1. The server checks the icap value locally for the different types of inventory c1, c2, c3,c4. In this example, for a first time call the icap data will not be available locally so the server will take the default icap (e.g., a small value, such as 1) and will do further processing.

2. Now suppose that the inventory c2 is finally owned and served. The icap count is then decremented locally by 1. In this example, the default icap is assumed to also be 1. As the icap count is now <=0, an updated icap quota (e.g., say 100) will be fetched from central store and set locally for further use.

3. Thus, after step 2 we have icap for c1=1,c2=100,c3=1,c4=1.

4. The Server again get a call and one of the inventories cl, c2, c3, and c4 is selected.

5. Whichever campaign wins will decrement the icap locally by 1.

### Dynamic Quota Mechanism

In one embodiment the icap quota fetched by server will be dynamic and will be decided as per the remaining icap at central store. Initially the server will be unaware of the icap at the central store so it will fetch a minimal quota at first. Once it knows the icap at the central store it will decide its quota accordingly as below:

An icap_quota_factor is one of the deciding factors to calculate a dynamic quota. In one implementation a default value for the icap_quota_factor is 5.

An icap_minimum_quota is a minimum icap quota.

An icap_max_quota is a maximum icap quota.

A factor value is based on the data center server count and the icap quota server as follows:
factor=dc_server_count*icap_quota_factor

Then using these expressing the updated (next) icap quota is given by the following expression to adjust the next icap quota based on the remaining icap at the central store, the icap minimum quota, and the factor value:

next_quota = icap_minimum_quota
if( remaing_icap_at_central_store > icap_minimum_quota * factor){
next_quota = remaing_icap_at_central store/factor;
if(icap_max_quota < next_quota){
next_quota = icap_max_quota;
}
}

### Icap Estimation Algorithm

In one embodiment, and estimate is formed for the icap at some initial time period for the central store, such as at the beginning of the day (the 0th hour with respect to the beginning of a new time period). This estimate may be weighted based on how many impressions were served in the previous time period by the data server. However, if no impressions were served in the previous time period by the data center, then the estimate can be based on the percentage of servers in the data center, or by other techniques. A default number can also be set to each server.

For example, in one embodiment each day the chron analysis module 360 will run in each data center. This provides the number of impressions served by the data center in the previous time period. This is performed to decide the maximum number of impressions to be served for the day, which is updated in the central store. This update is performed for all active inventories.

In one implementation, the update will depend on the total number of impressions to be served today multiplied by the percentage of impressions served yesterday by the data center then the following algorithm may be used:
Impression_to_be_served_by_dc=total_impression_to_serve_today*% of impression_served_yesterday_by_dc

However, suppose that in the previous time period that no impressions were served by that data center. In this situation a different algorithm may be used:
If impression_served_yesterday_by_dc is zero for a DC then
Impression_to_be_served_by_dc=total_impression_to_serve_today*% of server in that DC.

By default, an icap of 1 is given to all server this is accommodated in estimation by below step:
Impression_to_be served_by_dc=Impression_to_be served_by_dc−total server_in_dc
Impression_to_be served_by_dc will be set in central store.

### Estimate and Serve Undelivered Impression

As previously discussed, in one embodiment the cron analysis module 360 monitors the impressions that are actually served on a user browser. An impression is counted served only if it is served on a user's browser. This improves accuracy. For example suppose that an auction happens at the publisher end. Suppose some of the impressions are lost. This may arise from problems in the network through which the impression is served to the end user or for other technical reasons. In this situation, the lost impressions need to be re-delivered.

A redelivery algorithm may be implemented on a period basis. In one implementation an algorithm to redeliver lost impressions is followed every 15 minutes, although it will be understood that the algorithm could be repeated with other periodicities. An exemplary redelivery algorithm is as follows:

a. Find out all active inventories whose icap is finished at central store in a DC.

b. If the icap is finished 15 min before current time at central store for given DC then:
Remaining_Impression_to_serve_by_DC=total_impression_to_serve_today_by_DC−impression_already_served
If Remaining_Impression_to_serve_by_DC>lowest_quota*machine_count_in_dc
Remaining_Impression_to_serve_by_DC=Remaining_Impression_to_serve_by_DC−(lowest_quota*machine_count_in_dc)
else if Remaining_Impression_to_serve_by_DC<lowest_quota*machine_count_in_dc
Remaining_Impression_to_serve_by_DC=0

c. Set Remaining_Impression_to_serve_by_DC in central store.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

We claim:

1. A method of tracking the serving of ads to users across different geographic areas, the method comprising:
providing two or more geographically distributed data centers, each of the data centers assigned to serve ad impressions to client computers within a geographical area associated with the data center respectively,
each of the data centers including a central store and at least two ad servers to serve a first ad impression to individual web browsers;
assigning an impression cap to each of the data centers for the first ad;
storing the impression cap in the central store of each of the data centers;
operating each of the data centers to serve the first ad within its associated geographical area respectively by:
assigning to each of the two ad servers a cap quota for serving the first ad, the cap quota a subset of the impression cap;
arranging for the two ad servers to serve the first ad to client computers respectively;
determining when each of the two ad servers has exhausted its cap quota respectively;
dynamically updating the cap quota, for the first ad server and the second ad server, each time the cap quota or the dynamically updated cap quota for the first ad server and the second ad server has been exhausted respectively; and
decrementing the impression cap at the central store of each of the data centers after each dynamic update respectively.

2. The method of claim 1, further comprising collecting chronological information on impressions of the first ad that have been served by each of the data centers and providing the chronological information to the central store of each of the data centers respectively.

3. The method of claim 1, further comprising adjusting the dynamically determined cap quota updates based on whether the decremented impression cap quota is greater than a minimum default quota multiplied by a pre-determined factor.

4. The method of claim 1, wherein a chronological analysis is performed periodically in each of the data centers to determine the maximum number of impressions of the first ad to be served for an upcoming time period respectively.

5. The method of claim 1, wherein the impression cap assigned to each of the data centers has at least one of a daily, hourly, lifetime, and geo level limits.

6. The method of claim 1, wherein the impression cap quota assigned at any one time to an individual server is small compared to the impression cap for the data center over a time window.

7. The method of claim 1, wherein the inventory includes at least one of mobile, web, and video.

8. A method of coordinating the serving of ads to users across different geographic areas, the method comprising:
providing two or more geographically separated data centers where each data center is assigned to serve impressions of ads to client computers within a geographical area associated with the data center respectively;
coordinating a total impression cap for each type of inventory across the two or more geographically separated data centers by providing an impression cap to each data center for each type of inventory respectively
in a first data center associated with a first geographical location:
maintaining the impression cap for each type of inventory in a first central store accessible by the first data center;
arranging for at least two servers, associated with the first data center, to serve each type of inventory to client computers within the first geographic area, the at least two servers serving each type of inventory in accordance with a cap quota for each type of inventory respectively;
dynamically refreshing the cap quota for each type of inventory as each of the at least two servers exhausts the cap quota for each type of inventory respectively, the refreshed cap quota for each type of inventory deducted from the impression cap maintained in the central store for each type of inventory respectively; and
decrementing the impression cap for each type of inventory at the first central store of the first data center after each dynamic refresh of the cap quota for any of the at least two servers respectively.

9. The method of claim 8, further comprising collecting chronological information on impressions of each type of inventory that has been served by the first data center and providing the chronological information to the first central store of the first data center.

10. The method of claim 8, further comprising adjusting the refreshed cap quota based on whether the decremented impression cap is greater than a minimum default quota multiplied by a pre-determined factor.

11. The method of claim 8, wherein a chronological analysis is performed periodically in each of the two or more data center to determine the maximum number of impressions to be served for each type of inventory respectively.

12. The method of claim 8, wherein the impression cap maintained in the central store of the first data center has at least one of a daily, hourly, lifetime, and geo level limits.

13. The method of claim 8, wherein the cap quota assigned at any one time to any of the two or more servers for each type of inventory is relatively small compared to the impression cap maintained by the first record store for the first data center during a time window.

14. The method of claim 8, wherein the inventory for an inventory includes at least one of mobile, web, and video impressions.

15. The method of claim 1, further comprising selecting the refresh cap quota based on a latency consideration to keep latency within a selected limit.

16. The method of claim 15, further comprising selecting the refresh cap quota to avoid an under-serve or over-serve condition.

17. The method of claim 8, further comprising selecting the refresh cap quota based on a latency consideration to keep latency within a selected limit.

18. The method of claim 17, further comprising selecting the refresh cap quota to avoid an under-serve or over-serve condition.

19. A method for coordinating the serving of ads to users across different geographic areas, the method comprising:
providing two or more geographically separated data centers, wherein each data center is assigned to serve two or more geographical areas respectively;
storing a total impression cap for an impression at storage facility accessible by an administration center;
enforcing the total impression cap for the impression over at least two different geographic locations by:
assigning a first impression cap for the impression to a first data center, the first impression cap less than the total impression cap and stored in a first store accessible by the first data center;
assigning a second impression cap for the impression to a second data center, the second impression cap less than the total impression cap and stored in a second data store accessible by the second data center;
configuring the first data center to serve the impression to client computers in an associated first geographic location by:
assigning an impression quota to each of two or more servers associated with the first data center;
arranging for the two or more servers to serve the impression up to the impression quota;
ascertaining when each of the two or more servers has exhausted its impression quota;
updating the impression quota for each of the two or more servers when the impression quota has been exhausted respectively and arranging the two or more servers to continue serving the impression in accordance with the updated quota; and
decrementing the first impression cap in the first store each time one of the two or more servers exhausts and updates its impression quota;
configuring the second data center to serve the impression to client computers in an associated second geographic location by:
assigning an impression quota to each of two or more servers associated with the second data center;
arranging for the two or more servers associated with the second data center to serve the impression up to the impression quota;
ascertaining when each of the two or more servers associated with the second data center has exhausted its impression quota;
updating the impression quota for each of the two or more servers associated with the second data center when the impression quota has been exhausted respectively and arranging the two or more servers to continue serving the impression in accordance with the updated quota;
decrementing the second impression cap in the second store each time one of the two or more servers exhausts and updates its impression quota;
decrementing the total impression cap at the storage facility accessible by the administration center each time the first impression quota and the second impression quota for the first and second data centers are exhausted and updated respectively; and
stopping the serving of the impression when the total impression cap is exhausted.

20. The method claim 1, wherein the two or more geographically distributed data centers are each located in different time zones.

21. The method claim 8, wherein the two or more geographically separated data centers are each located in different time zones.

22. The method claim 19, wherein the two or more geographically separated data centers are each located in different time zones.

23. The method of claim 8, further comprising for a second data center associated with a second geographical location:
maintaining a second impression cap for each type of inventory in a second central store accessible by the second data center;
arranging for at least two servers, associated with the second data center, to serve each type of inventory to client computers within the second geographic area, the at least two servers serving each type of inventory in accordance with a second cap quota for each type of inventory respectively;
dynamically refreshing the second cap quota for each type of inventory as each of the at least two servers exhausts the second cap quota for each type of inventory respectively, the refresh second cap quota for each type of inventory deducted from the second impression cap maintained in the second central store for each type of inventory respectively.

24. The method of claim 23, further comprising:
refreshing the first impression cap and the second impression cap for each type of inventory maintained by the first and second central stores of the first and second data centers when the first impression cap and the second impression cap for each type of inventory are exhausted respectively; and
decrementing the total impression cap for each type of inventory following each refresh.

25. A method of operating a distributed ad network, the method comprising:
maintaining, at an administrative storage location on the ad network, a total impression cap for each type of inventory to be served by the ad network respectively;
providing two or more data centers, each data center including a storage element and at least two ad servers and servicing a defined geographic area respectively;
distributing to the two or more data centers a data center level impression cap for each type of inventory served by the ad network, the impression cap for each type of inventory stored in the storage element of each data center respectively; and
operating each data center by:
providing to each of the at least two servers an impression cap quota for each type of inventory, the impression cap quota for each type of inventory less than the data center level impression cap for each type of inventory respectively;
(a) arranging for each of the at least two servers to serve each type of inventory up to the impression cap quota for each type of inventory respectively;
(b) determining when each of the at least two servers has exhausted its cap quota for each type of inventory;
(c) updating each of the at least two servers with an updated cap quota for each type of inventory when exhausted;
(d) decrementing the data center level impression cap in the storage element by the amount of the updated cap quota following each exhaustion and update; and
(e) repeating (a) through (d) until the data center level impression cap is exhausted.

26. The method of claim 25, further comprising:
(f) decrementing the total impression cap for each type of inventory maintained in the administrative storage location on the ad network when the data center level impression cap for each type of inventory is exhausted by the two or more data centers and updated respectively; and
(g) stopping the serving of each type of inventory when the total impression cap is exhausted respectively.

27. The method of claim 25, wherein operating each data center further comprises collecting chronological information on impressions of each inventory type served.

28. The method of claim 25, wherein each server in each data center is initially assigned a minimum default quota of impressions to be served for each type of inventory respectively.

29. The method of claim 28, wherein after each server has served up a minimum default cap quota of impressions, each subsequent updated cap quota is selected to be within a range between the minimum default quota and a maximum quota.

30. The method of claim 25, further comprising adjusting the default cap quota based on whether the remaining decremented impression cap is greater than the minimum default cap quota multiplied by a pre-determined factor.

31. The method of claim 25, wherein a chronological analysis is performed periodically in each data center to determine the maximum number of impressions to be served for an upcoming time period.

32. The method of claim 25, wherein the impression cap for each data center has at least one of a daily, hourly, lifetime, and geo level limits.

33. The method of claim 25, wherein the inventory includes at least one of mobile, web, and video.

34. The method of claim 1, further comprising stopping the serving of the first ad when a total impression cap has been reached.

35. The method of claim 1, further comprising stopping the serving of each type of inventory when a total impression cap for each type of inventory has been reached respectively.
